(19) United States
(12) Patent Application Publication
(10) Pub. No.: US 2004/0255174 A1
(43) Pub. Date: Dec. 16, 2004

(54) METHOD OF CONTROLLING THE OPERATIONAL MODE OF A COMPUTER SYSTEM

(76) Inventors: Lu-De Chen, Taipei City (TW); Chien-Chih Yu, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,461

(22) Filed: Sep. 30, 2003

(30) Foreign Application Priority Data
Jun. 16, 2003 (TW) 092116312

(51) Int. Cl. G06F 1/26

(52) U.S. Cl. 713/300

(57) ABSTRACT

A method of controlling the operational mode of a computer system is disclosed. When the power supply of the computer system is switched from a first power supply to a second power supply, detect how long the second power supply supplies power to the computer system. If the second power supply supplies power for less than a predetermined period, change the operational mode of the computer system, otherwise remain in the current operational mode of the computer system.

### BACKGROUND OF INVENTION

1. Field of the Invention

The present invention relates to a method of controlling the operational mode of a computer system, and more specially, to a method of changing the operational mode of the computer system according to the period that a battery supplies power to the computer system.

2. Description of the Prior Art

A computer system generally comprises an AC/DC adapter for providing electronic components installed in the computer system with power. An overload protection circuit is usually used for protecting the computer system from being damaged due to excessive power consumption. However, as the operational frequency of the computer system improves, the power consumption required by the computer system correspondingly increases. Generally speaking, the maximum power consumption of the central processing unit (CPU) is approximately between 60 W and 90 W and that of other peripheral devices is 16 W. This means that the total power consumption of the computer system is approximately between 76 W and 106 W. However, the usual standard AC/DC adapter provides 90 W and 120 W.

Moreover, in most situations, the computer system is used for text editing, or playing VCD or DVD disks. These are operations in which the CPU does not operate at the maximum operational frequency, and therefore, cause lower power consumption. If using a 120 W AC/DC adapter, the extra power consumption of 14 W-44 W is wasted, since the CPU does not keep running at the maximum operational frequency. In addition, the size of the AC/DC adapter is proportional to its maximum supply power. That is, the AC/DC adapter that is able to provide more power usually has a larger size. If a higher power AC/DC adapter is obtained, the larger size is inconvenient for users to carry.

For a proper operation of the computer system, a 90W AC/DC adapter can provide sufficient power to the computer system. Please refer to FIG. 1, which is a time sequence diagram of system power consumption of a prior art computer system, and shows a transient power consumption of the computer system. The x-axis in FIG. 1 indicates time, and the y-axis indicates system power consumption of the computer system. The maximum power provided by the AC/DC adapter is noted as P_{MAX} of 90 W, and before increasing the operational frequency of computer system, the maximum power P_{MAX} is sufficient for the system power consumption of computer system. After increasing the operational frequency, the transient power consumption of the computer system is generally less than P_{MAX}. However, when executing certain programs or executing too many programs at the same time, the transient power consumption of the computer system possibly exceeds the maximum power P_{MAX} provided by the AC/DC adapter. Consequently, the computer system is unstable and the overload protection circuit is started to shut down the computer system. For example, during the time period from T1 to T2 shown in FIG. 1, the transient power consumption exceeds P_{MAX} of the AC/DC adapter. Therefore, when a central processing unit (CPU) executes more programs, which causes increased power consumption, the maximum power consumption of the computer system increases and exceeds the maximum power P_{MAX} provided by the original AC/DC adapter. Additionally, the overload protection circuit of the AC/DC adapter is started due to the exceeding power consumption so as to stop providing power for the computer system. This causes the computer system to shut down unexpectedly. Therefore, most computer systems include batteries for temporarily supplying power to the computer systems until the AC/DC adapter resumes providing power.

### SUMMARY OF INVENTION

It is therefore a primary objective of the claimed invention to provide a method of changing the operational mode of the computer system according to the power supply period of the battery in order to solve the above-mentioned problems.

Briefly summarized, the claimed invention is a method of controlling the operational mode of a computer system. When the power supply of the computer system is switched from a first power supply to a second power supply, detect how long the second power supply supplies power to the computer system. If the second power supply supplies power to the computer system for less than a predetermined period, change the operational mode of the computer system, otherwise leave the operational mode of the computer system unchanged.

Wherein, the computer system is a notebook, the first power supply is an AC/DC adapter connected to an AC power source, and the second power supply is a battery. Furthermore, if the second power supply supplies power to the computer system for less than a predetermined period, the operational frequency of the CPU, the electronic devices, or the bus can be lowered so as to reduce power consumption of the computer system.

It is an advantage of the claimed invention that the operational mode of the computer system is determined by detecting how long the second power supply supplies power to the computer system. In this way, the computer system has the optimal working efficiency.

These and other objectives of the claimed invention will no doubt become obvious to those of ordinary skill in the art after reading the following detailed description of the embodiment, which is illustrated in the various figures and drawings.

### BRIEF DESCRIPTION OF DRAWINGS

FIG. 1 is a time sequence diagram of system power consumption of portable computer in the prior art.

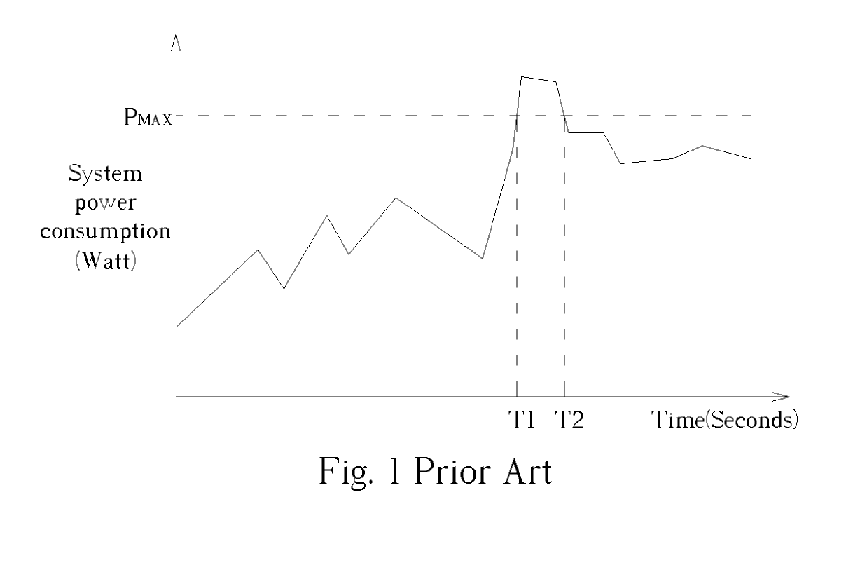

FIG. 2 is a block diagram of a computer system according to the present invention.

FIG. 3 is a flowchart illustrating controlling the operational mode of the computer system according to the present invention.

FIG. 4 illustrates a timing diagram with respect to an AC detecting signal.

### DETAILED DESCRIPTION

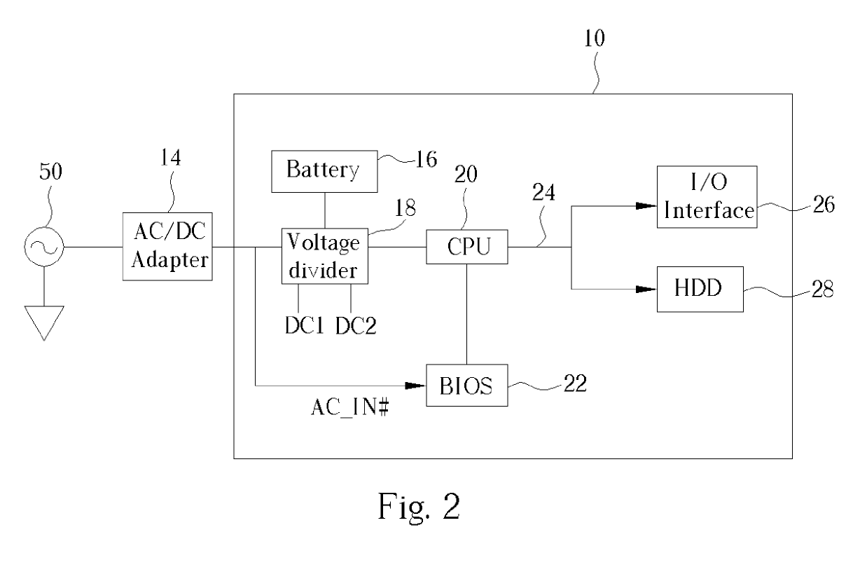

Please refer to FIG. 2, which shows a block diagram of a computer system 10 according to the present invention. The computer system 10 can be a notebook computer and comprises a battery 16, a voltage divider 18, a basic input output system (BIOS)22, a central processing unit(CPU)20 for processing program and data, an I/O interface 26, a hard disk drive (HDD) 28, and a bus 24. The required power of the computer system 10 is supplied by the battery 16 or an AC/DC adapter 14 electrically connected to an AC power source 50 (for example commercial AC power). The AC/DC adapter 14 is used for transforming an AC voltage provided by the AC power source 50 into a steady state DC voltage and supplying the DC voltage to the computer system 10. The voltage divider 18 electrically connected to the AC/DC adapter 14 is used for transforming the output DC voltage of the AC/DC adapter 14 to a plurality of DC voltages of different values and then applying the plurality of DC voltages to different electronic components of the computer system 10. The I/O interface 26 could be a graphical interface, a network interface, or a sound effects interface, and is used to communicate data to other devices (such as the HDD 28) through the bus 24.

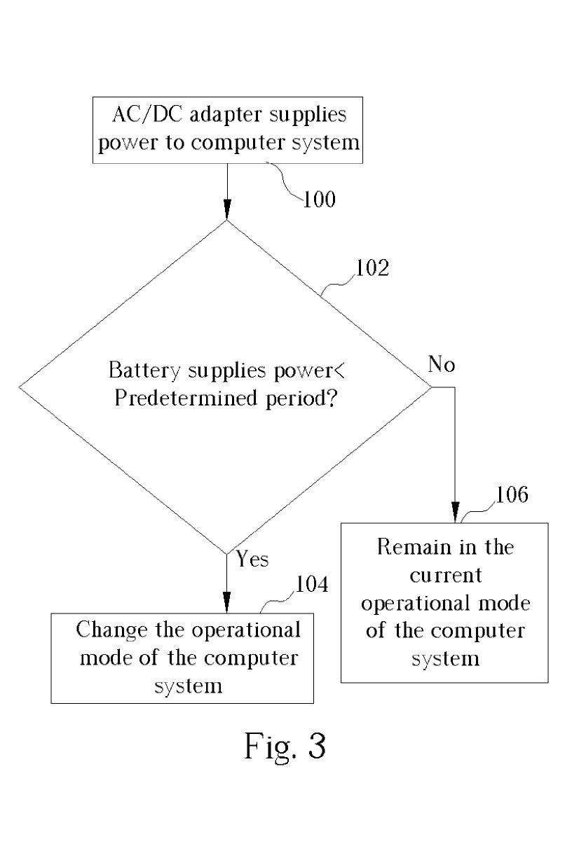

Please refer to FIG. 3. FIG. 3 is a flowchart illustrating the operational mode controlled by the computer system 10 according to the present invention. The steps occur as follows:

Step 100: The computer system 10 is supplied power by the AC/DC adapter 14.

Step 102: When the power supply of the computer system is switched from the AC/DC adapter 14 to the battery 16, detect whether the battery 16 supplies power to the computer system 10 for less than a predetermined period. If yes, go to step 104, if not, go to step 106.

Step 104: Change the operational mode of the computer system 10.

Step 106: Remain in the current operational mode of the computer system 10.

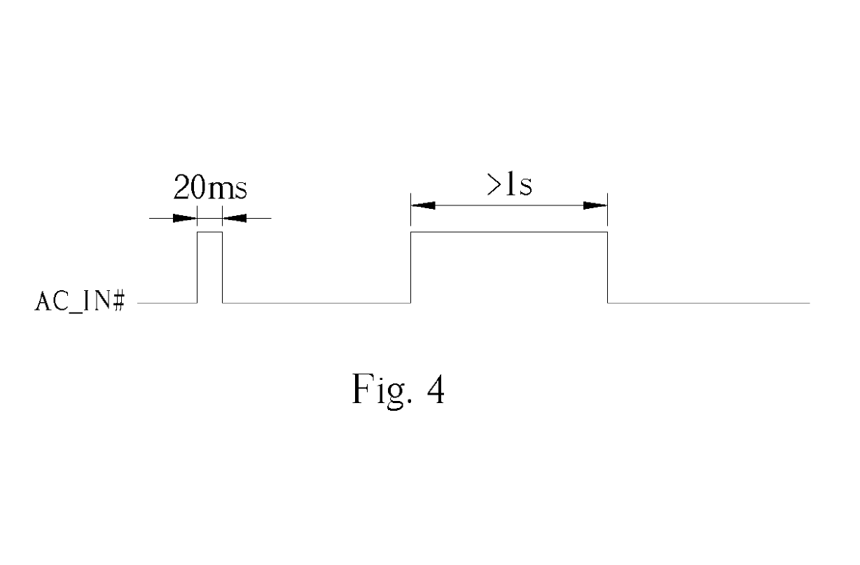

Please refer to FIG. 3 in conjunction with FIG. 4. FIG. 4 illustrates a timing diagram with respect to an AC detecting signal. In the normal operational mode, the computer system 10 is supplied power by the AC/DC adapter 14 which sends a detecting signal AC_IN# with a logical “1” to the BIOS 22 (step 100). However, when the power requirement of the computer system 10 spikes and exceeds the maximum power provided by the AC/DC adapter 14, the ACDC adapter 14, due to a load protection of the AC/DC adapter 14, suspends providing power to the computer system 10. Meanwhile, the battery 16 substitutes the ACDC adapter 14 to supply power to prevent data loss, and the BIOS 22 receives a detecting signal AC_IN# with a logical “0”, representing that the AC/DC adapter 14 is not providing power to the computer system 10. Until the ACDC adapter 14 supplies power to the computer system 10 again, the BIOS 22 receives the detecting signal AC_IN# with a logical “1”. The BIOS 22 determines whether the period of the detecting signal AC_IN# being a logical “0” is smaller than a predetermined period of 25 msec (step 102). Generally, the above predetermined period is about 25 millisecond (msec). This predetermined period is due to the switched period from the AC/DC adapter 14 to the battery 16 being about 10-20 millisecond. If the period of the battery 16 supplying power to the computer system 10 is smaller than the predetermined period, this means that the AC/DC adapter 14 of the computer system 10 is overloaded. In this situation, the computer system 10 lowers the operational frequency of the CPU 20, the operational frequency of the electronic devices of the computer system 10 such as the HDD 28 or the I/O interface 26, or the clock of the bus 24, to reduce the total power consumption of the computer system 10. The computer system 10 is thereby protected from being damage due to overload (step 104). If the period that the battery 16 supplies power to the computer system 10 is equal to or longer than the predetermined period, this means that the AC/DC adapter 14 has stopped supplying power for a long time (at least more than 20 msec) (step 106). This is caused when the AC/DC adapter 14 fails to supply power to the computer system 10 for some reason. For instance, the user wants to move the computer system 10 from his office to another meeting room and the power supply of the AC/DC adapter 14 is temporarily cut off. In other words, this situation does not result from overload of the AC/DC adapter 14. Therefore, when the AC/DC adapter 14 starts to re-supply power to the computer system 10 (i.e. the BIOS 22 detects the detecting signal AC_IN# with logical “1” again), and the detecting signal AC_IN# with logical “0” was detected for at least 20 msec, the AC/DC adapter 14 supplies power to the computer system 10 normally, without reducing the operational frequency of the CPU 20, the HDD 28 or the I/O interface 26, or reducing the clock rate of the bus 24.

Compared to the prior art, the present invention method is capable of controlling the operational mode of the computer system by detecting how long the battery supplies power to the computer system when the power supply of the computer system is switched from the AC/DC adapter to the battery to determine whether the computer system is overloaded. When overloaded the operational frequency of the CPU or other devices of the computer system, the operational frequency needs to be lowered to reduce the power consumption. Therefore, by using the present invention method, if the computer system is capable of lowering the operational frequency of the computer system to reduce the power consumption, a lower power AC/DC adapter is sufficient for most users” requirements. In this way, without purchasing a high power AC/DC adapter with higher price, the computer system using a lower power AC/DC adapter can normally run in most conditions, and is capable of lowering the operational frequency when overloaded. Consequently, the present invention computer system does not need a high power adapter, which is an environmental choice due to reduction of cost and power consumption.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of controlling the operational mode of a computer system comprising the following steps:
(a) detecting how long a second power supply supplies power to the computer system, when the power supply of the computer system is switched from a first power supply to the second power supply; and
(b) changing the operational mode of the computer system, if the second power supply supplies power for less than a predetermined period, otherwise remaining in the current operational mode of the computer system.

2. The method of claim 1, wherein the first power supply is an AC/DC adapter electrically connected to a commercial alternating current source.

3. The method of claim 1, wherein the second power supply is a battery.

4. The method of claim 1, wherein if the second power supply supplies power for less than a predetermined period, lowering the operational frequency of a CPU, electronic devices, or a bus of the computer system to reduce power consumption of the computer system.

5. The method of claim 1, wherein the computer system is a notebook computer.

6. A computer system for performing the method of claim 1.

7. A method of controlling the operational mode of a computer system comprising the following steps:
(a) detecting how long a battery supplies power to the computer system, when the power supply of the computer system is switched from an AC/DC adapter electrically connected with a commercial alternating current source to the battery; and
(b) changing the operational mode of the computer system, if the battery supplies power for less than a predetermined period, otherwise remaining in the current operational mode of the computer system.

8. The method of claim 7, wherein if the battery supplies power for less than a predetermined period, lowering the operational frequency of a CPU, electronic devices, or a bus of the computer system to reduce power consumption of the computer system.

9. The method of claim 7, wherein the computer system is a notebook computer.

10. A computer system for performing the method of claim 7.
